(19) United States
(12) Patent Application Publication
(10) Pub. No.: US 2026/0094100 A1
(43) Pub. Date: Apr. 2, 2026

(54) SYSTEMS AND METHODS FOR AUTOMATING CLOUD ARCHITECTURE OPTIMIZATION USING A GENERATIVE ARTIFICIAL INTELLIGENCE ORCHESTRATOR

(71) Applicant: AT&T Intellectual Property I, L.P., Atlanta, GA (US)

(72) Inventors: Venkateswarlu Maddi, Cumming, GA (US); Anthony Snead, Johns Creek, GA (US); Narendra Avineni, McKinney, TX (US); Christopher Hambrick, Dallas, GA (US); Rama Raghavan, Frisco, TX (US)

(73) Assignee: AT&T Intellectual Property I, L.P., Atlanta, GA (US)

(21) Appl. No.: 18/898,800

(22) Filed: Sep. 27, 2024

(51) Int. Cl. G06Q 10/0637; G06F 9/50

(52) U.S. Cl. CPC G06Q 10/06375; G06F 9/5077

(57) ABSTRACT

Aspects of the subject disclosure may include, for example, running a virtual agent to initiate retrieval of information about cloud subscriptions and cloud resource properties; connecting the virtual agent with a generative artificial intelligence (GenAI) server via a first application programming interface (API) and a second API; with the first API, parsing the information about cloud subscriptions and cloud resource properties and generating a prompt for cost saving recommendations; with a second API, filtering the prompt and sending the prompt that complies with security policies to the GenAI server; and with the GenAI server, generating cloud architecture optimization (AO) recommendations in response to the prompt. Other embodiments are disclosed.

### FIELD OF THE DISCLOSURE

The subject disclosure relates to systems and methods for automating cloud architecture optimization using a generative artificial intelligence orchestrator.

### BACKGROUND

Public Cloud vendors (e.g., Azure®, Amazon Web Services (AWS), Google Cloud, etc.) offer many different services that can be configured and used by customer enterprises to customize applications. In order to design cost effective applications, one approach is that knowledgeable architects at customer enterprises manually review public cloud services provided solutions and configurations for applications and recommend changes that can save costs. One of challenges of that approach is how to scale such effort for a large organization that has a huge number of applications migrated into the public cloud. In some cases, monthly expenses for applications migrated to the public cloud of a large organization may exceed predetermined budgets, thereby requiring more cost effective solutions. Moreover, it is time consuming and labor extensive for public cloud experts to analyze public cloud subscriptions manually by reviewing a large number of applications migrated into the public cloud.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of system interfaces functioning within the system of FIG. 2A in accordance with various aspects described herein.

FIG. 2C is a block diagram illustrating an example, non-limiting operation of the system of FIGS. 2A-2B in accordance with various aspects described herein.

FIG. 2D depicts one use case example of a virtual agent/chatbot application in accordance with various aspects described herein.

FIG. 2E is a block diagram illustrating an example, non-limiting operation of another system in accordance with various aspects described herein.

FIG. 2F depicts an illustrative embodiment of a method in accordance with various aspects described herein.

FIG. 2G depicts an illustrative embodiment of another method in accordance with various aspects described herein.

FIG. 2H depicts an illustrative embodiment of yet another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods for automating cloud architecture optimization (AO) using a generative artificial intelligence (GenAI) orchestrator. The cloud AO may include improvement or betterment, such as selecting from among a group of improved architectures depending on one or more factors that are to be improved, such as cost savings. The systems and methods implement automation of the cloud AO process of applications migrated into a public cloud. The systems and methods inspect application cloud subscriptions and provide an application specific guidance to re-factor a large number of applications to reduce spending for using public cloud services. Users are presented with multiple channels for providing information of cloud applications to be analyzed via user interfaces. The systems and methods process the provided information and generate, using a GenAI orchestrator, prompts or queries or instructions to a GenAI server to generate AO recommendations. The generation of prompts or queries or instructions may be automated, which will allow the GenAI server to generate consistent AO recommendations in a cost- and time-effective manner. Subject matter experts such as AO architects provide AO guidelines to a vector database for training the GenAI server and for performing a cognitive search by the GenAI server in order to generate the AO recommendations. Other embodiments are described in the subject disclosure.

One or more aspects of the subject disclosure are directed to a device including a processing system having a processor and a memory that stores executable instructions that, when executed by the processing system, facilitate performance of operations. The operations include running a virtual agent to initiate retrieval of information about cloud subscriptions and cloud resource properties; connecting the virtual agent with a generative artificial intelligence (GenAI) server via a first application programming interface (API) and a second API; with the first API, parsing the information about cloud subscriptions and cloud resource properties and generating a prompt for cost saving recommendations; with a second API, filtering the prompt and sending the prompt that complies with security policies to the GenAI server; and with the GenAI server, generating cloud architecture optimization (AO) recommendations in response to the prompt.

One or more aspects of the subject disclosure are directed to a non-transitory machine-readable medium, comprising executable instructions that, when executed by a processing system including a processor, facilitate performance of operations. The operations include receiving, via a virtual agent, a cloud architecture optimization (AO) request with respect to a target application migrated into a public cloud subscribed by a customer enterprise; calling, by the virtual agent, a server API to parse an input object containing cloud resource properties owned by a subscription of the target application and generating a prompt using templates; invoking a generative artificial intelligence API (GenAI API) which performs security policy validations of the prompt; upon passing of the security policy validations of the prompt, sending the prompt to a GenAI server; and generating, by the GenAI server, cloud architecture optimization (AO) recommendations.

One or more aspects of the subject disclosure are directed to a method including receiving, by a processing system of a generative artificial intelligence (GenAI) orchestrator including a processor, identification of a target cloud application migrated into a public cloud subscribed by a customer enterprise; establishing connections, by the processing system, among a server API, a generative artificial intelligence API (GenAI API), and a virtual agent or a batch process; automatically generating, by the processing system, using the server API, a prompt based on a plurality of rules, wherein the prompt is configured to instruct generation of cloud architecture optimization (AO) recommendations directed to cost savings with respect to the target cloud application; sending, by the processing system, the prompt to a generative artificial intelligence (GenAI) server via the GenAI API; and returning, by the processing system, the generated cloud AO recommendations to the virtual agent or the batch process.

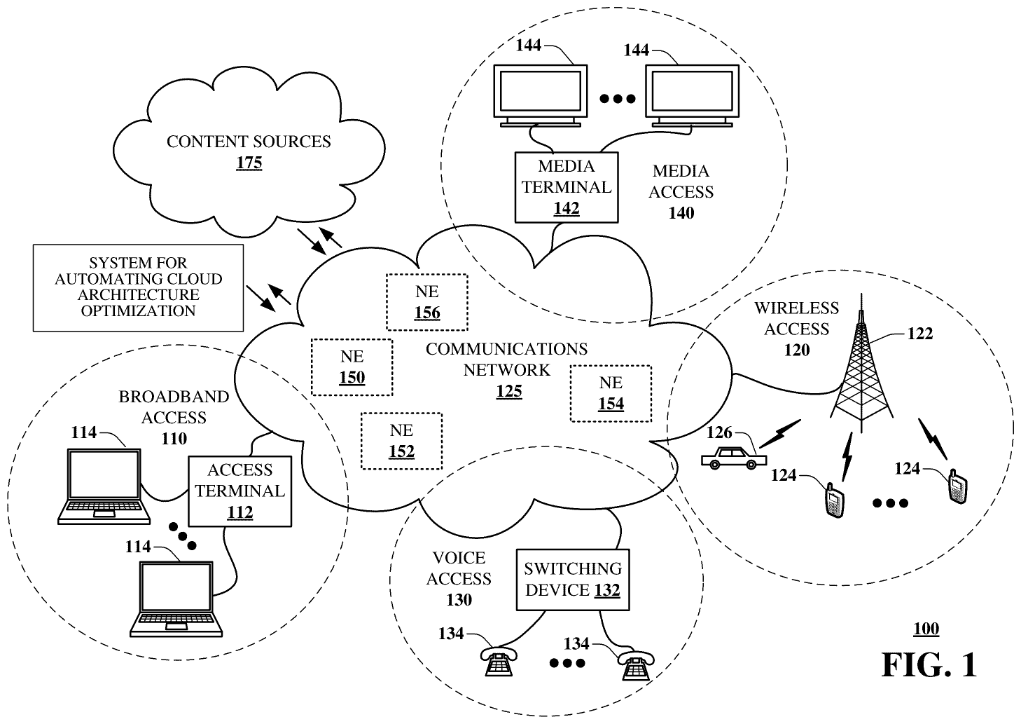

Referring now to FIG. 1, a block diagram is shown illustrating an example, non-limiting embodiment of a system 100 in accordance with various aspects described herein. For example, system 100 can facilitate in whole or in part systems and methods for automating cloud architecture optimization using a generative artificial intelligence orchestrator. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132, media access 140 to a plurality of audio/video display devices 144 via media terminal 142 and/or system for automating cloud architecture optimization analysis. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

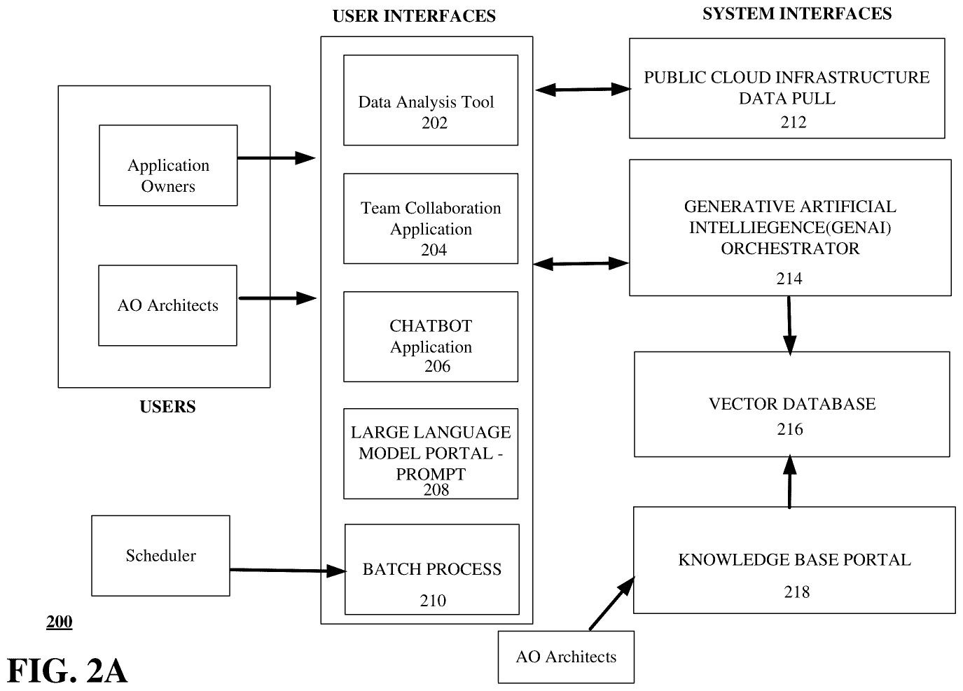

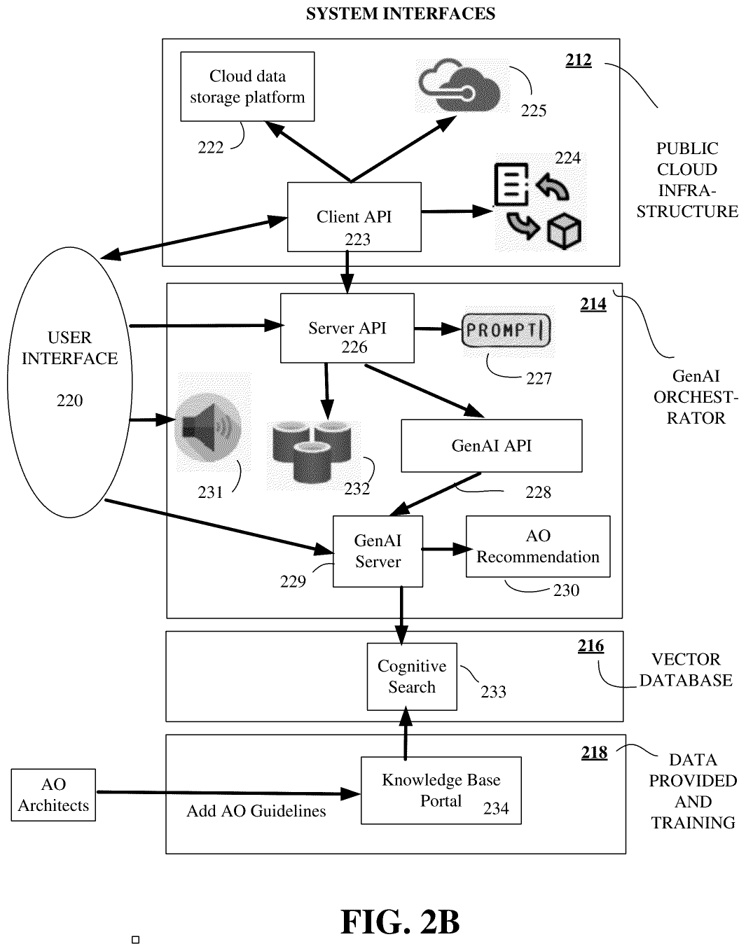

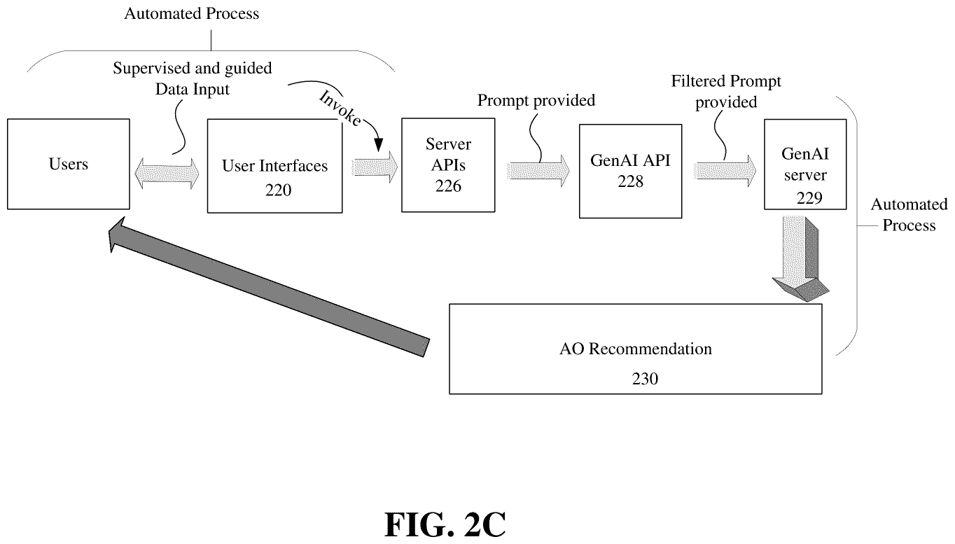

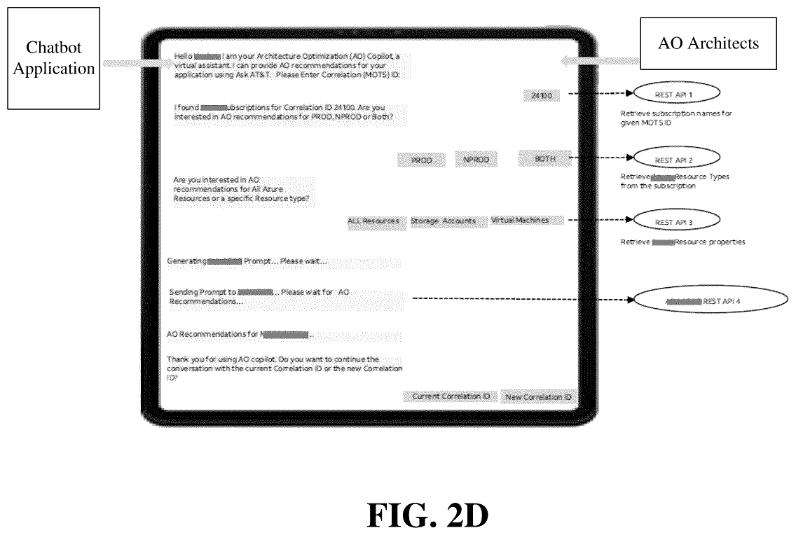

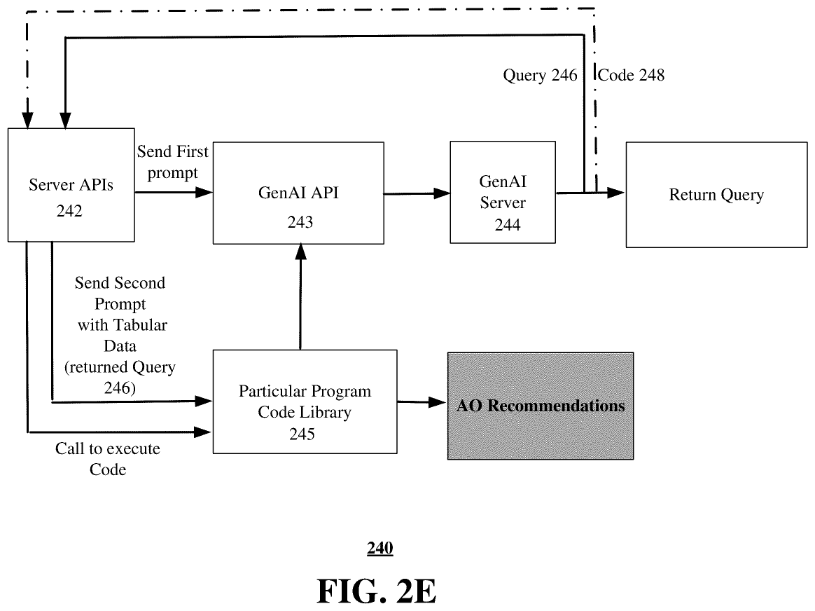

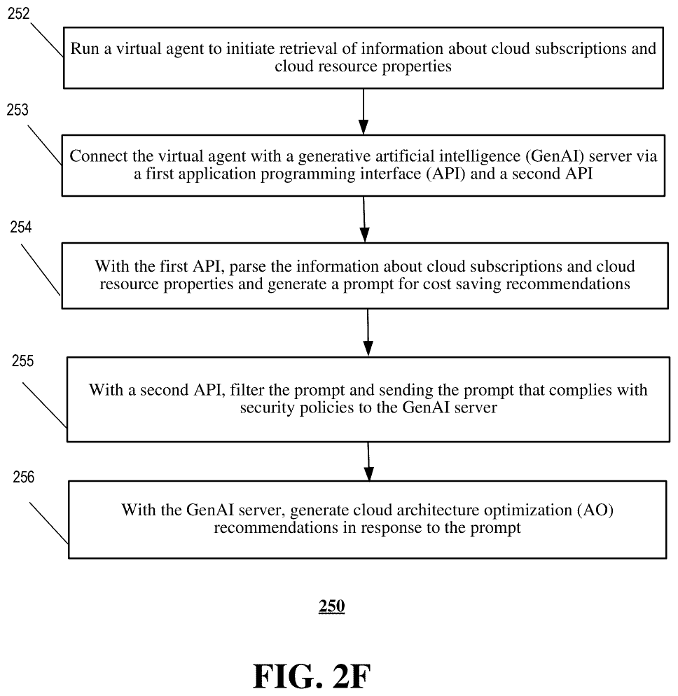

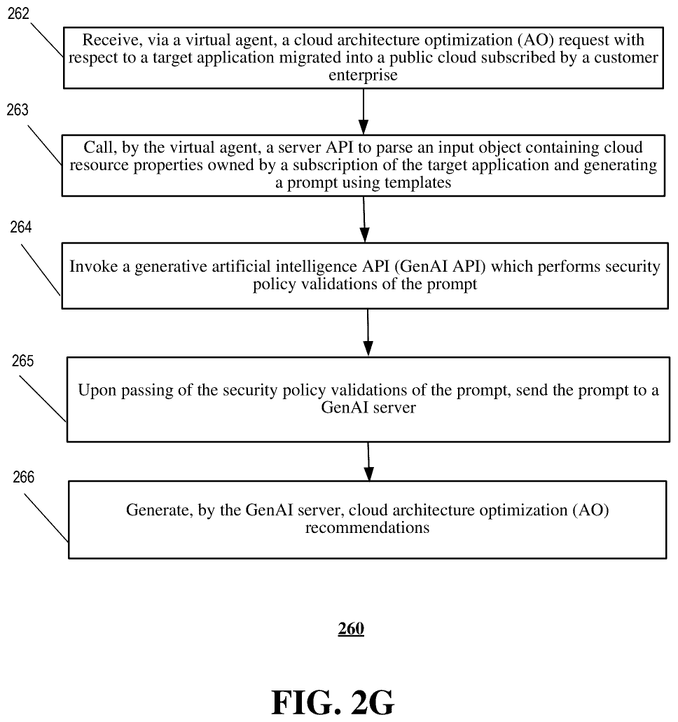

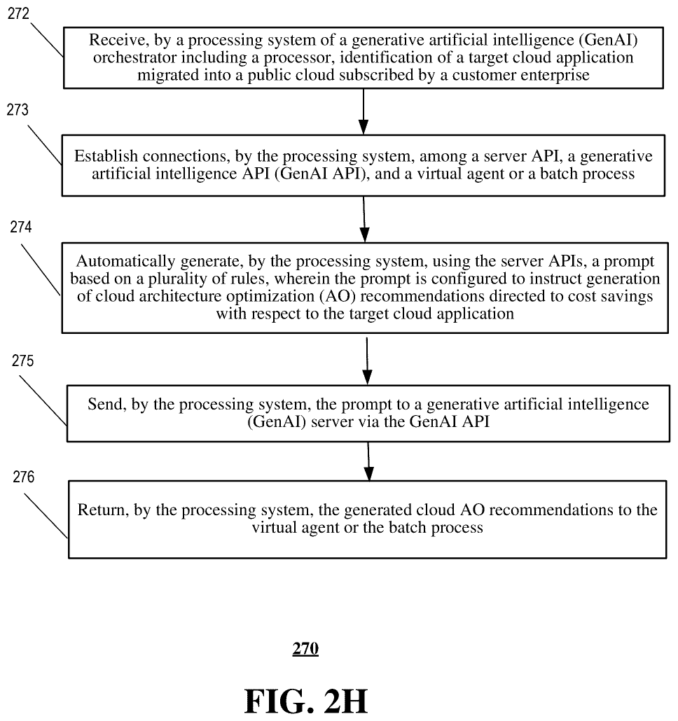

FIG. 2A is a block diagram illustrating an example, non-limiting embodiment of a system 200 functioning within the communication network of FIG. 1 in accordance with various aspects described herein. Public cloud architecture optimization (“AO”) analysis has been predominantly manual activities. Manual activities can result in inconsistent analysis results. The public cloud AO analysis may take a long time (e.g., 2-3 weeks per application for a pool of a few thousand applications) and such timeline can be subject to further changes depending on schedules and availability of coordinating teams such as application teams. All of the foregoing factors may slow down realization of savings that could be obtained through the public cloud architecture optimization analysis.

The present disclosure is directed to systems and methods for automating cloud architecture optimization (“AO”) using a generative artificial intelligence (GenAI) orchestrator. Artificial intelligence is implemented with computer systems capable of performing tasks normally requiring human intelligence. Machine learning (ML) is a subfield of artificial intelligence which is a program or a system that trains a model and gives a computer ability to learn. Supervised ML models utilize labeled data with tags and unsupervised ML models utilize unlabeled data such as raw data. Deep learning is a subset of ML and uses neural networks, which can process more complex patterns than traditional ML. Generative AI is a subset of deep learning which uses neural networks and process labeled data and unlabeled data. Large language models (LLMs) are a subset of deep learning. Deep learning model types are discriminative and generative. The discriminative type AI is used to classify or predict and trained on a dataset of labeled data. The generative type AI generates new data that is similar to data it was trained on and predicts new content, for example, next word in a sequence. The generative type AI generates new content such as natural language, image, audio, etc.

The generative type AI (GenAI) takes inputs of training codes, labeled data and/or unlabeled data and builds a foundation model. The foundation models are pretrained with vast quantity of data and are designed to be fine-tuned to perform many downstream tasks, such as question answering, sentiment analysis, information extraction, etc. The foundation model can generate new content such as text, code, image, etc. GenAI creates new content based on learning from existing content through training and results in the creation of a statistical model. In response to a prompt, GenAI uses this statistical model to predict a response to be generated as new content. For instance, generative language models learn about patterns in language through training data and in response to some text, next word may be predicted. LLMs are one example of generative language models. Generative language models utilize pattern matching and show a list of high probability results.

Generative language models utilize a transformer including encoding component and decoding component. The decoded input by the transformer is provided to a generative pre-trained transformer model which generates an output. Prompt is a short message of text that is given to an LLM as an input. The quality of input through the prompt can determine the quality of output of the LLM. Prompt controls the output of the LLM. One use case of generative language models are training generative language models to perform a specific task or action based on text input. The task can be a wide range of actions such as answering a question, performing a search, making a prediction, etc. and applications implementing such actions include, for example, virtual assistants, automation, etc.

Domain knowledge in ML refers to expertise and understanding of a specific field or subject matter to which a ML model is applied. The integration of Large Language Models (LLMs) into specialized domains like medicine, law, and finance expand the boundaries of ML applications in these fields. LLMs can be equipped with the necessary domain-specific knowledge and reasoning abilities. General-purpose LLMs are available to cover general knowledge and language tasks, but general-purpose LLMs may lack the depth and nuance required for specialized fields. General-purpose LLMs can be adapted or fine-tuned to specific fields by using domain-specific knowledge and training.

As described above, a prompt in a LLM is a set of instructions or text that tells the LLM model what to do or how to respond. Components of a prompt include a task, system instructions, few-shot examples, and/or contextual information. Prompt engineering involves crafting questions or prompts that guide the ML model to generate outputs tailored to a specific domain. Prompt engineering operates to extract domain-specific knowledge from a generic LLM without modifying its architecture or undergoing retraining. Accordingly, prompt engineering aims to optimize the entire ML system to ensure reliable, efficient, and safe performance. Prompt engineering is the technical, model-centric discipline focused on optimizing the prompts and instructions to elicit desired outputs from the underlying AI system. This is more relevant for the implementation and development of the AI model itself. Prompt engineering refers to the technical process of crafting the specific language and instructions used to elicit desired outputs from AI models. This involves careful consideration of factors like word choice, structure, tone, and context to optimize the model's response. The goal of prompt engineering is to precisely specify the task at hand and guide the AI system to provide the most relevant, accurate, and useful information.

For comparison, prompt design focuses on crafting effective prompts and involves formulating clear, effective instructions or queries that guide AI language models to generate accurate and relevant responses. Effective prompt design is crucial for obtaining desired outputs and avoiding biases or misleading information from AI models. In summary, prompt design is centered on user experience, while prompt engineering is focused on the technical implementation and design of the ML model. For instance, prompt engineering is for use in the implementation and design of the AI model, and prompt design is for use with chatbots. Prompt design is the user-centric practice of crafting prompts that provide a seamless and intuitive experience when interacting with AI-powered chatbots and assistants. Prompt design focuses more on the user experience and the broader application of AI capabilities. Prompt design involves considering the natural flow of human-AI interaction, anticipating user needs and constraints, and crafting prompts that seamlessly integrate the AI assistant into the user's tasks and objectives.

In various embodiments, using a generative artificial intelligence (GenAI) orchestrator, the systems and methods in accordance with various embodiments described herein inspect application subscriptions and provide application specific guidance to re-factor a large number of applications deployed in the public cloud in order to achieve a reduction in spending for using public cloud services. After cloud applications are migrated to cloud, cloud architecture optimization in accordance with various embodiments described herein is performed as post cloud migration effort in order to optimize the cost.

In various embodiments, the system 200 includes user interfaces configured to receive input data from users. Users include application owners (e.g., developers) and cloud architecture optimization architects, etc. by way of example. Application owners and cloud architecture optimization architects (“AO architects”) initiate an AO process or a transaction activity. As depicted in FIG. 2A, a scheduler is configured to schedule and kick off or trigger a batch process on a regular basis, such as once per month. For instance, every first day of each month, the batch process 210 is scheduled and run as a background process. By way of example only, the batch process 210 scans all of cloud subscriptions within an enterprise specific public cloud, one subscription at a time. The batch process 210 covers each resource and scans like a client application programming interface (API).

In various embodiments, users are presented with various interfaces which facilitate multiple channels. With respect to the same input data, users can utilize a data analysis tool 202, a team collaboration application 204, a chatbot application 206, and/or a large language model (LLM) portal 208.

In various embodiments, users can use the data analysis tool 202 which receives the input data from users and perform data analysis as directed by users, which is directed to cloud AO analysis. The data analysis tool 202 may use artificial intelligence/machine learning (AI/ML) techniques to enhance the data analysis. Users can use the team collaboration application 204 to perform the cloud AO analysis. Users may be presented with the chatbot application 206 which communicate with users to receive necessary input or information (e.g., a storage account identification (ID)) by guiding users. The chatbot application 206 is configured to provide a chatbot interface where users can initiate a request for AO recommendations. The chatbot application 206 is well suited for routine tasks like customer support and informational retrieval. The chatbot application 206 is implemented by different types of chatbots, including rule-based, AI-powered, hybrid, predictive AI, conversational AI, voice bots, or a combination thereof.

In various embodiments, the user interfaces may be configured to provide a virtual agent to users. The chatbot application 206 may be one example of the virtual agent. The virtual agent can use text chat or voice commands, allowing for a more natural conversation. The virtual agent or the chatbot application 206 may be customized or modified based on a level of tasks needed or expected to be handled and users'needs or users'requests. For instance, if the level of tasks is directed to receiving inputs from users, the chatbot application 206 can be customized to perform the level of tasks. As another example, if the level of tasks is directed to analyzing users'input data and performing analysis tasks such as classification, identification, prediction, etc., the virtual assistant may be implemented with AI-powered or with a large language model based tool using a prompt. Additionally, the scheduler and batch processing may be performed in an automated manner without intervention or involvement of human users as a background process. The batch processing can initiate a request for AO recommendations, in addition to users'initiation via the user interfaces.

As depicted in FIG. 2A, users can utilize the LLM portal 208 and directly provides prompts to a generative artificial intelligence (GenAI) server. Additionally or alternatively, the system 200 includes a GenAI orchestrator 214 configured to provide GenAI application programming interfaces which facilitate automating generation of prompts and AO recommendations.

In various embodiments, the system 200 further includes system interfaces in communication with users via the user interfaces. Typically, the public cloud system bills or charges for applications running by using the resources provided by the public cloud system. Public cloud infrastructure data pull 212 provide subscription information such as subscription types, subscription resources, subscription resource properties or attributes, etc. The public cloud infrastructure data pull 212 is provided to the user interfaces. One or more channels on the user interfaces will call, with the data pull as input parameters, the GenAI orchestrator 214 which is configured to receive inputs from users directly or via the channels on the user interfaces, and ultimately recommend cloud AO solutions in using the public cloud resources, as output data. For instance, an AO architect or an App owner (e.g., a developer) is communicating with the chatbot application 206 which in turn invokes the GenAI orchestrator 214 based on input received from the AO architect or the App owner. At least one component of the GenAI orchestrator 214 is subject to training to analyze the inputs from the AO architect or the App owner and output optimization recommendations.

In various embodiments, the GenAI orchestrator 214 accesses a vector database 216 and performs a cognitive search. Data stored in the vector database 216 may be provided by AO architects via a knowledge base portal 218. AO architects correspond to subject matter experts in public cloud resource optimization and provide relevant data or information via the knowledge base portal 218. Additionally, AO architects further provide AO guidelines via the knowledge base portal 218 such that the GenAI orchestrator 214 can be trained to follow and comply with the AO guidelines. Upon an AO request from users, the GenAI orchestrator 214 accesses the information and the guidelines stored in the vector database 216, compares the information and results and provides the AO recommendations.

In various embodiments, the AO recommendations are directed to resource consolidation, resources optimization, logging optimization, Platform as a Service (PaaS) optimization and PaaS change, converting Infrastructure as a Service (IaaS) to PaaS/Software as a Service (SaaS), etc. LaaS is a cloud-based log management platform that simplifies the management and infrastructure and application logs. PaaS provides hardware and application software platforms to customers using cloud server. SaaS works through cloud servers that host application software and provides ways to deliver these applications via the internet. IaaS is the foundation for building cloud-based services, while PaaS allows developers to build applications without hosting them. AO recommendations including IaaS to PaaS/SaaS, PaaS optimization and changes, Resource consolidation and resources optimization, can lead to significant cost savings in utilizing the public cloud resources.

FIG. 2B is a block diagram illustrating an example, non-limiting embodiment of system interfaces functioning within the system of FIG. 2A in accordance with various aspects described herein. In various embodiments, connectivity can be established between users and the GenAI orchestrator 214 using user interfaces 220 in order to perform tasks of automating public cloud resource optimization analysis. In FIG. 2B, the user interfaces 220 may be implemented as a virtual agent that establishes the connectivity between users (as shown in FIG. 2A) and the GenAI orchestrator 214 including a GenAI server 229. By way of example only, the virtual agent may be generated using a guided graphical interface without using code. As another example, the virtual agent may be generated using a commercially available application that is customized to be compatible with the public cloud system and the GenAI orchestrator 214.

As will be further described in connection with FIG. 2D below, the virtual agent can provides a supervised data collection process by presenting queries to users and receiving guided information in response to the queries. As one example, the virtual agent asks users to enter identification information (ID) of application(s) that users are interested in obtaining AO recommendations. Once the ID of application(s) is determined, the virtual agent can ask follow-up questions relevant to the determined application(s), as shown in FIG. 2D. Such guided information is used to generate prompts or queries or instructions for the GenAI server 229. Additionally, the virtual agent interacts with a client API 223 and a server API 226 to dynamically generate a prompt and ultimately return AO recommendations to users. In various embodiments, one or more client APIs and/or one or more server APIs can be used, and the present disclosure is not limited to a particular number of client API(s) and server API(s).

In various embodiments, the public cloud infrastructure 212 includes a client application programming interface (API) 223 which interfaces users and various applications and platforms on the public cloud. The client API 223 interface a cloud data storage platform 222 which also can perform cloud data computing based on various subscription arrangements. The client API 223 further interface between users and data transformation and between users and public cloud graph APIs 225. The client API 223 pull, from the public cloud, data including cloud properties (e.g., storage accounts, virtual machines, cloud functions, etc.) owned by the subscription to be analyzed for the AO and send the pulled data to the user interfaces 220.

Additionally or alternatively, the client API 223 handle the data pulled from the public cloud. The client API 223 retrieve the cloud service properties from the cloud data storage platform 222. If the cloud data storage platform 222 does not contain the required information, then client API 223 interact with other APIs operating in the public cloud and retrieve the service properties. The data pulled from the cloud will be sent back to the user interfaces 220. Then, the user interfaces 220 call the server API 226 with the data pull (the cloud service properties) as input parameters. The server API 226 send the cloud service properties to the GenAI API 228. The GenAI API 228 may be an infrastructure structure and an API platform for hosting multiple APIs. A new API can be deployed to support different use cases. For instance, a new API for a library that handles particular format files (e.g., CSV files), can be deployed.

In various embodiments, the GenAI orchestrator 214 includes server API 226 configured to parse the properties of the cloud resources and generate an appropriate prompt 227 asking for cost saving recommendations, as depicted in FIG. 2B. A public cloud cache 232 enables high-performance and scalable architectures. The public cloud cache 232 may be used to reduce tokens utilization by the GenAI server 229. A prompt and query may result in a cache. The server API 226 verify the existence of the prompt in the cache. If the prompt exists in the cache, then the Server API 226 retrieve the query from the public cloud cache 232. The GenAI orchestrator 214 further includes applications that convert text input data from users to speech data 231 such that speech based processing may be supported.

In various embodiments, the server API 226 are connected to a GenAI API 228 which is connected to a GenAI server 229. Additionally or alternatively, users can be directly connected to the GenAI server 229 via the user interface 220. The user interface 220 (e.g., the chatbot application 206, the batch process 210) invokes the server API 226 with JSON payload input. The JSON payload contains the public cloud's properties. The server API 226 parse the input JSON object and generates the prompt dynamically using templates. The server API 226 then invoke the GenAI API 228, which contain security policies like sensitive personal information (SPI) data prevention, payment card information (PCI) data prevention, etc. The GenAI API 228 is configured to filter the prompt to ensure that no customer sensitive or proprietary information is passed. Some examples of the security policy validations executed by the GenAI API 228 are cases where the prompt contains social security numbers, credit card numbers, customer proprietary network information, obscene word(s), etc., then the GenAI API 228 rejects the prompt and send an error message back to the server API 226. In various embodiments, the GenAI API 228 interacts with the GenAI server 229. When the GenAI API 228 finds no security policy concern, then the prompt is passed to the GenAI server 229. The GenAI API 228 is further configured to send the prompt to the GenAI server 229 in order to get a response. The GenAI server 229 generates and outputs AO recommendations 230.

In various embodiments, the GenAI API 228 is considered as a gateway that ensures that prompts may not contain customers'and enterprises'sensitive and proprietary information. A high-level call flow between users and the GenAI server 229 is described as follows:

### Example Flow 1: Users to the GenAI Server Call Flow Via the User Interfaces

1. App Owner→Chatbot Application→Client API 223
2. Chatbot Application→Server API 226→Generate prompt 227 dynamically
3. Server API 226 invoke the GenAI API 228 with the generated prompt 227
4. GenAI API 228→GenAI server 229
5. GenAI server 229 compare the prompt 227 with the Vector Database 216 (Cognitive Search 233)
6. GenAI server 229→AO Recommendations 230

### Example Flow 2: Batch Process to the GenAI Server Call Flow

1. Scheduler→Batch Process→Client API 223
2. Batch Process→Server API 226→Generate prompt 227 dynamically
3. Server API 226 invoke the GenAI API 228 with the generated prompt 227
4. GenAI API 228→GenAI server 229
5. GenAI server 229 compares the prompt 227 with AO guidelines in the Vector Database 216 (Cognitive Search 233)
6. GenAI server 229→AO Recommendations 230

In various embodiments, AO architects provide AO guidelines to the vector database 216 via a knowledgebase portal 234. AO architects also upload AO guidelines to the vector database 216. The GenAI server 229 can perform cognitive searches 233 using data stored in the vector database 216. The GenAI server 229 may be trained using the AO guidelines uploaded to the vector database 216. During training, the GenAI server 229 is trained based on AO guidelines and sample data relating to various applications that are migrated into the public cloud and output data containing optimization results prepared by AO architects based on the AO guidelines. For instance, the sample data includes data, properties describing the public cloud resources owned by the subscription that users desire to obtain AO recommendations.

In various embodiments, the GenAI server 229 utilizes generative AI techniques which is an intuitive, conversational platform that can interact in natural language. There are a variety of use cases for the generative AI techniques. As one example, the generative AI techniques may be available for software developers to use it to write and refine code. In some embodiments, the generative AI techniques corresponds to Large Language Models (LLMs). In some cases, the generative AI techniques may use open-source LLM architectures as and if needed. Different LLMs are suited for different applications and have different cost structures. The generative AI techniques can process natural language requests and analyze data. This functionality will query data, i.e., automatically detecting fields, joining tables and creating the code and present a comprehensive analysis from vast data flows provided as the input data.

In some embodiments, LLMs uses artificial intelligence algorithm and is trained with large data sets to understand input and generate and predict output. LLMs are used for natural language processing applications where a user inputs a query in natural language and LLMs can be used to generate a response relevant to the user's query. By way of example only, LLMs may use generative pre-trained transformers (GPT) which are a family of models that use deep learning to generate natural language or code from a given input. To implement the architecture of GPT, neural networks are used to process text or speech, and vast amounts of unstructured (often unlabeled) text data are used in a training stage. As depicted in FIG. 2B, AO architects provide the AO guidelines via the knowledge base portal 234 to the vector database 216. The AO guidelines and training data may be used in a training stage of the GenAI server 229. By way of example, training data may include a particular type of application as input data and specific AO recommendations as output data based on past experience, past statistical data or information, knowledge and data collected and provided by AO architects, etc. Adjustment and modification to the AO guidelines and/or training data, which may be driven by business needs or operational or performance changes, can be reflected or updated as needed, periodically or on a specific schedule. The present disclosure is not limited to particular LLMs, and operators or users can select the size and the complexity of LLM models to meet their budget and their expected level of accuracy.

In accordance with various embodiments described herein, LLMs can be trained on a massive amount of data and enabled to perform various tasks such as analyzing data provided, identifying or determining applications to be deployed or not as a way of optimization and outputting optimization recommendations. In some embodiments, LLMs operate very effectively with a proper prompt, which includes texts or a set of instructions that users provide to LLMs to trigger a specific response or action. The prompt is a way of users communicating with LLMs. As depicted in FIG. 2A, users may directly provide a prompt using the large language model portal 208. Additionally, or alternatively, the server API 226 and/or the GenAI API 228 generate prompts based on input provided via the user interface 220.

By way of example only, the AO guidelines may contain rules to identify attributes for generating AO recommendations, including and not limited to, a storage account name, a subscription name, access tier, a lifecycle flag, a subscription tier, a version flag, a usage rate of a storage account, an archive duration, a secure file transfer protocol (SFTP) feature. The following are non-limiting examples of AO recommendations.
General Recommendation 1: If there is a significant amount of data that is being duplicated, removing the duplication can greatly reduce storage costs. This may drive changes to the application's logic but is worth at least considering.
General Recommendation 2: Please consider using compression format (parquet, delta for read heavy, AvroTM for write heavy) to increase efficiency.
General Recommendation 3: Consider creating larger size files for better performance and to lower cost.
General Recommendation 4: When you enable blob soft delete for a storage account, you specify a retention period for deleted objects of between 1 and 365 days. The retention period indicates how long the data remains available after it is deleted or overwritten. Please keep the retention period as minimum as possible per application requirement to reduce cost.

FIG. 2C is a block diagram illustrating an example, non-limiting operation of the system of FIGS. 2A-2B in accordance with various aspects described herein. In various embodiments, users interact with applications or channels supported on the user interfaces 220. By way of example, the chatbot application 206 on the user interfaces 220 interacts with users and facilitates supervised and guided data input. FIG. 2D depicts one example of a chatbot application supporting supervised and guided data input. By way of example, the chatbot application is configured to prompt text messages to users which notifies and requires necessary pieces of information in order to render AO recommendations. The test messages depicted in FIG. 2D are by way of example only and the present disclosure is not limited thereto. The chatbot application depicted in FIG. 2D or other forms of virtual agent continue to present text messages and navigate to obtain necessary pieces of information to the extent that a prompt to be provided to the GenAI server 229 can be generated in accordance with predefined logics. The information presented to users by the chatbot application or virtual agent is collected in order to generate a proper prompt to be fed to the GenAI server 229. The GenAI server 229, as depicted in FIG. 2C, generates the AO recommendation 230.

In various embodiments, the chatbot application or the virtual agent may retrieve public cloud subscription information, resource properties, resource details, etc. in order to invoke the server API 226. The server API 226 parse the properties of the cloud resources and generate an appropriate prompt asking for cost saving recommendations. The generated prompt template may be reusable and stored or maintained. The GenAI API 228 filters the prompt to ensure that no customer SPI information or proprietary information is passed. The GenAI API 228 has all information about inputs to the GenAI server 229. The GenAI API 228 provides the filtered prompt to the GenAI server 229.

In various embodiments, when users need to prepare the AO recommendation 230, users initiate a request and are presented with chat messages by applications on the user interfaces 220. Users follow the presented chat messages and provide the requested information. Behind scenes transparent to users, the information is provided to the server API 226, along with information obtained from the client API 223 (shown in FIG. 2B), and the prompt is generated by the server API 226 by parsing such information. The prompt instructs the GenAI server 229 to generate the AO recommendation 230. Thus, an entire process of obtaining the AO recommendation 230 is automated and users obtain the AO recommendation by interfacing the applications on the user interfaces 220. The automated process as depicted in FIG. 2C may generate consistent AO recommendations in a time-effective and cost-effective manner.

In various embodiments, the optimization recommendations may provide highly relevant and effective solutions to the public cloud resource optimization. A primary focus of the public cloud resource optimization is directed to cost savings. The AO recommendation may have a shared pricing structure and calculates optimal cost-saving amounts from multiple recommendations. The AO recommendation may analyze all public cloud applications (by way of example only, approximately 2,500 applications).

FIG. 2E is a block diagram illustrating another example, non-limiting embodiment of a system 240 in accordance with various aspects described herein. In various embodiments, the system 240 includes a server API 242, a GenAI API 243, and a particular program code library 245. In the system 240, the server API 242, invoked by the virtual agent of users with cloud properties as input, in turn invoke the GenAI API 243. The GenAI server 244 is expected to generate consistent and accurate guidelines, irrespective of user interfaces (e.g., the virtual agent or the batch process shown in FIG. 2A). The system 240 facilitates and implements a special logic to generate consistent results from multiple executions. By way of example, two prompts can be provided to the GenAI server 224. Additionally, in the system 240, the server API 242 further invoke the particular program code library 245.

In various embodiments, the system 240 operates as follows. Users initiate conversation from the virtual agent, as described in connection with FIG. 2A˜2B above. Then, the virtual agent calls the server API 242 with the public cloud service properties as input. The server API 242 invoke the GenAI API 243 and the particular program code library 245, as shown below by way of example:
App Owner→AO virtual agent→Client API 223 (FIG. 2B)
AO virtual agent→Server API 242 (FIG. 2E)→Generate Prompt Dynamically (First Prompt)
Server API 242→Invoke GenAI API 243 (with the generated prompt)→GenAI server 244 return a Query 246 to the Server API 242
Server API 242→Particular program code library 245→Invoke the GenAI API 243 (with the returned Query)→GenAI server 244→Generate code (e.g., Python code)
Server API 242→Execute the code using Particular program code library 245→Generate AO Recommendations.

In various embodiments, when the server API 242 invoke the GenAI API 243, a first prompt is provided to the GenAI API 243. For instance, the server API 242 invoke the GenAI API 243 to generate a Structured Query Language (SQL) query. Such API call by the server API 242 contains input parameters and output parameters. The input parameters include a prompt and Rule IDs (e.g., Storage Account Rule IDs, SP.1, SP.2, SP.3, etc.) and the output parameters are a SQL query. The prompt describes instructions for the GenAI server 244 to generate the SQL query using the Rule IDs. The GenAI server 244 will compare the Rule IDs in the vector database (shown in FIGS. 2A-2B) and generate the SQL query 246.

In various embodiments, the server API 242 invoke the particular program code library 245 with the generated query in order to generate particular program code (e.g., Python code). The particular program code library 245 may be a library built with the same code (e.g., Python code) and configured to interact with a GenAI server such as the GenAI server 244. The particular program code library 245 is called with input parameters and output parameters. The input parameters include the prompt and the SQL query 246 as described above. The output parameters include the particular program code. The prompt contains verbiage instructing the GenAI server 244 to generate the particular program code using the SQL query 246. The GenAI server 244 generates the particular program code 248 and the server API 242 calls the particular program code library 245 to execute the code. As a result, AO recommendations are generated.

In various embodiments, the particular program code library 245 executes codes using files having a particular format such as comma-separated values (CSV) files. The CSV file is a text file format that stores data in a table-like structure using commas to separate values and newlines to separate records. The CSV file is used for importing data into software programs, exporting reports, etc. and frequently used in business settings. The particular program code library 245 can be used to process CSV files with high number of input records.

FIG. 2F depicts an illustrative embodiment of a method 250 in accordance with various aspects described herein. In various embodiments, the method 250 includes running a virtual agent to initiate retrieval of information about cloud subscriptions and cloud resource properties (Step 252), connecting the virtual agent with a generative artificial intelligence (GenAI) server via a first application programming interface (API) and a second API (Step 253), with the first API, parsing the information about cloud subscriptions and cloud resource properties and generating a prompt for cost saving recommendations (Step 254), with a second API, filtering the prompt and sending the prompt that complies with security policies to the GenAI server (Step 255), and with the GenAI server, generating cloud architecture optimization (AO) recommendations in response to the prompt (Step 256).

In various embodiments, the method 250 further includes receiving cloud AO guidelines by AO architects via a knowledge base portal, and storing the cloud AO guidelines in a vector database. The generating the cloud AO recommendations further includes, with the GenAI server, generating the AO recommendations by performing a cognitive search in the vector database. The method 250 further include training the GenAI server with a set of training data using input parameters retrieved from the cloud subscriptions and the cloud resource properties. The method 250 further includes presenting, with the virtual agent, guided queries to users to retrieve information relating to a target application migrated into a cloud.

In various embodiments, the method 250 further includes, with the first API, receiving, from the virtual agent, the cloud resource properties of the identified target application and parsing the cloud resource properties of the identified target application. The running the virtual agent further includes running a chatbot application to retrieve the information about at least identification information of the target application. The filtering the prompt further includes determining whether the prompt contains sensitive personal information, payment information, proprietary information, profane words, or a combination thereof. The method 250 further includes, with a second API, rejecting the prompt that fails to comply with security policies and sending an error message to the first API. The first API is a server API and the second API is a GenAI API.

FIG. 2G depicts an illustrative embodiment of a method 260 in accordance with various aspects described herein. In various embodiments, the method 260 includes receiving, via a virtual agent, a cloud architecture optimization (AO) request with respect to a target application migrated into a public cloud subscribed by a customer enterprise (Step 262), calling, by the virtual agent, a server API to parse an input object containing cloud resource properties owned by a subscription of the target application and generating a prompt using templates (Step 263), invoking a generative artificial intelligence API (GenAI API) which performs security policy validations of the prompt (Step 264), upon passing of the security policy validations of the prompt, sending the prompt to a GenAI server (Step 265), and generating, by the GenAI server, cloud architecture optimization (AO) recommendations (Step 266).

In various embodiments, the method 260 further includes invoking, by the virtual agent, a client API to retrieve the cloud resource properties owned by the subscription of the target application. The method 260 further includes receiving, via a batch process, the AO request with respect to a group of applications scanned by the batch process and migrated into the public cloud subscribed by the customer enterprise, and invoking, via the batch process, a client API to retrieve cloud resource properties relevant to the group of applications. The method 260 further includes calling, by the batch process, the server API to parse input objects containing the cloud resource properties relevant to the group of applications and generating another prompt using another templates, and invoking the GenAI API which performs the security policy validations of another prompt.

In various embodiments, the generating the cloud AO recommendations includes generating the cloud AO recommendations by comparing the prompt with a vector database using a cognitive search. The cloud AO recommendations are directed to cost savings by performing resource consolidation, resources optimization, logging optimization, Platform as a Service (PaaS) optimization and PaaS change, converting Infrastructure as a Service (IaaS) to PaaS/Software as a Service (SaaS), or a combination thereof. The method 260 further includes generating, with the server API, a first prompt that instructs the GenAI server to output a structured query language (SQL) query, invoking, with the server API, a particular program code library, generating, with the server API, a second prompt that instructs the GenAI server to output particular program code using the SQL query, and executing, with the server API, the particular program code to generate the AO recommendations. The first prompt includes a first instruction to generate the SQL query using rules IDs, and the second prompt includes a second instruction to generate the particular program code using the generated SQL query.

FIG. 2H depicts an illustrative embodiment of a method 270 in accordance with various aspects described herein. In various embodiments, the method 270 includes receiving, by a processing system of a generative artificial intelligence (GenAI) orchestrator including a processor, identification of a target cloud application migrated into a public cloud subscribed by a customer enterprise (Step 272), establishing connections, by the processing system, among server API, a generative artificial intelligence API (GenAI API), and a virtual agent or a batch process (Step 273), automatically generating, by the processing system, using the server API, a prompt based on a plurality of rules, wherein the prompt is configured to instruct generation of cloud architecture optimization (AO) recommendations directed to cost savings with respect to the target cloud application (Step 274), sending, by the processing system, the prompt to a generative artificial intelligence (GenAI) server via the GenAI API (Step 275), and returning, by the processing system, the generated cloud AO recommendations to the virtual agent or the batch process (Step 276).

In various embodiments, the method 270 further includes receiving, by the processing system, subscription properties of the target cloud application retrieved by client API via the virtual agent or the batch process, and parsing, by the processing system, using the server API, the subscription properties of the target cloud application to generate the prompt. The method 270 includes calling, by the processing system, a particular program code library, and connecting, by the processing system, using the server API, the particular program code library and the GenAI API to instruct the GenAI server to generate particular program code. The method 270 includes executing, by the processing system, using the server API, the generated particular program code, and generating, by the processing system, the AO recommendations based on the executed particular program code. The method 270 further includes facilitating, by the processing system, connections with user interfaces supporting multiple channels configured to provide a set of parameters relating to the target cloud application in different formats, wherein the multiple channels include the virtual agent and the batch process.

While for purposes of simplicity of explanation, the respective processes are shown and described as a series of blocks in FIGS. 2F through 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In various embodiments, the method further includes receiving, by the processing system, subscription properties of the target cloud application retrieved by a client API via the virtual agent or the batch process, and parsing, by the processing system, using the server API, the subscription properties of the target cloud application to generate the prompt. The method includes calling, by the processing system, a particular program code library, and connecting, by the processing system, using the server API, the particular program code library and the GenAI API to instruct the GenAI server to generate particular program code. The method includes executing, by the processing system, using the server API, the generated particular program code, and generating, by the processing system, the AO recommendations based on the executed particular program code. The method further includes facilitating, by the processing system, connections with user interfaces supporting multiple channels configured to provide a set of parameters relating to the target cloud application in different formats, wherein the multiple channels include the virtual agent and the batch process.

As described in the above embodiments, the systems and methods for automating cloud architecture optimization using a generative artificial intelligence application program interface are provided. The systems and methods invoke the GenAI APIs from the chatbot application or the virtual agent. The GenAI APIs are configured to generate prompt templates by retrieving necessary pieces of information such as public cloud subscription information and cloud resource. The generated reusable prompt templates are sent along with the public cloud resource details to the GenAI server. The identified cloud architecture may optimize cost-saving opportunities using the GenAI server. The systems and methods are configured to calculate the cost-savings for each public cloud resource based on the AO recommendations. The algorithm determines which recommendations have a shared pricing structure and calculates optimal cost-saving amounts from multiple recommendations. Additionally, the systems and methods support converting texts to speech and therefore, convert AO Recommendations to audio files and provide to users. The systems and methods may perform bulk Analysis of customer applications and create a framework to analyze all public cloud applications (approximately 2,500).

As described in the above embodiments, the public cloud subscriptions are inspected and application-specific cost-saving guidance using the GenAI server and the chatbot application or virtual agent supported on the user interface. The GenAI server is trained using guidelines/instructions which are provided by AO architects. The GenAI server may be retrained or updated based on feedback by AO architects. Application owners and architects can access this shared knowledge by way of the chatbot application or the virtual agent. The GenAI server recommends cost-saving changes for appropriate Subject Matter Experts (SMEs) to review and consider making to their applications deployed or to be deployed in the public cloud. Information about the subscription's resources is retrieved and then to the GenAI server which has been trained to understand the AO guidelines using the GenAI APIs which returns the recommendations. Text to Speech functionality is enabled such that chatbot users not only read but also listen the AO Recommendations. This is accomplished by using speech APIs supporting the GenAI server.

In the above described embodiments, the systems and methods can analyze a large number of public cloud application subscriptions automatically (e.g., about 2500 applications). The systems and methods can identify potential cost-saving opportunities and achieve a reduction in a monthly spend. The systems and methods can improve productivity by significantly reducing manual efforts involved in analyzing cloud subscriptions for cost-saving opportunities. Replacing the laborious manual process with the GenAI powered automation will likely improve productivity. The systems and methods can provide cost-effective guidelines to newly migrated applications into the public cloud for the first time or building cloud-native applications.

In the above described embodiments, the cloud architecture optimization is described as one of use cases. The systems and methods described above can facilitate other cases. One exemplary use case includes Encryption Policies Compliance. App teams implement in-transit and At-Rest encryption as per security policies. The systems and methods described in the above embodiments provide input data to the GenAI server to recommend Encryption policy guidelines to App teams like the way that the GenAI server identifies and outputs the AO recommendations as described above.

Further another use case example includes Application Classification. The application can be associated with a functional category per the Business Framework guidelines. The functional category examples are “Buy,” “Sales,” “Billing.” etc. The systems and methods described in the above embodiments provide input data to the GenAI server to recommend the Application category like the way that the GenAI server identifies and outputs the AO recommendations as described above.

In various embodiments, different uses cases can be implemented by using relevant guidelines prepared by respective subject matter experts and provided to the GenAI server for training and use. The systems and methods can provide the automated process of generating proper prompts (e.g., interactive questions) for users and the GenAI server in order to generate recommendations relevant to different use cases.

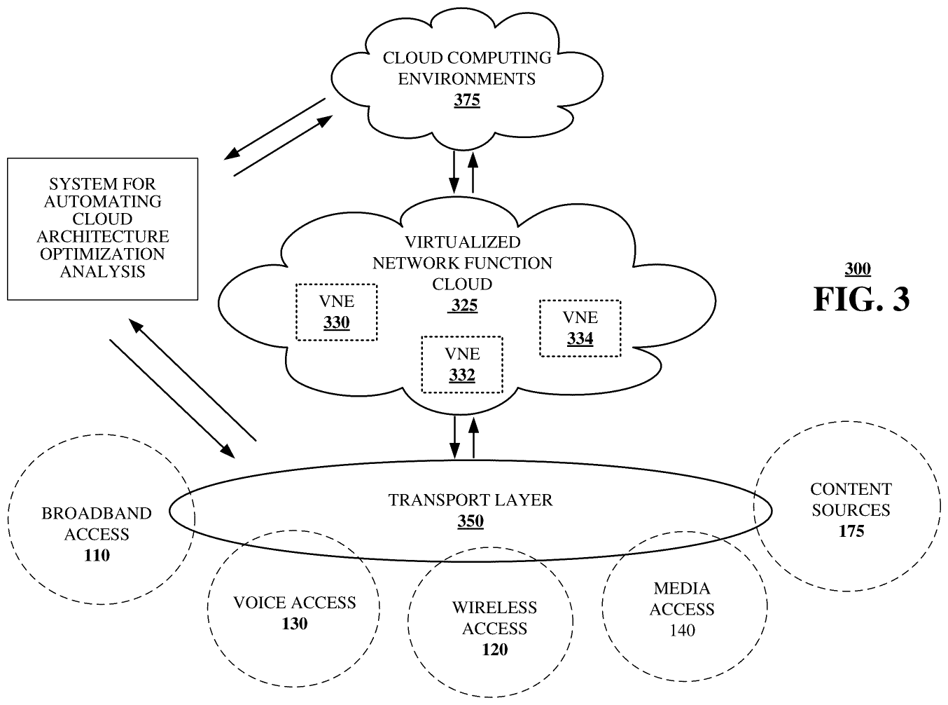

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and methods 240, 250, 260 and 270 presented in FIGS. 1, 2A, 2F through 2G, and 3. For example, virtualized communication network 300 can facilitate in whole or in part systems and methods for automating cloud architecture optimization using a generative artificial intelligence orchestrator, as depicted in FIG. 3.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

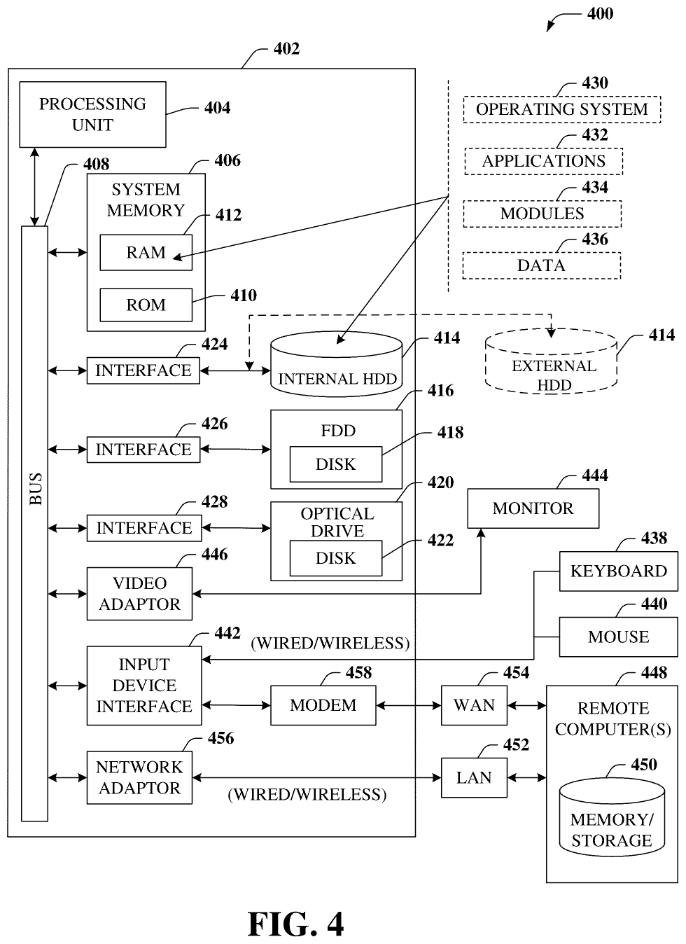

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods for automating cloud architecture optimization using a generative artificial intelligence orchestrator.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

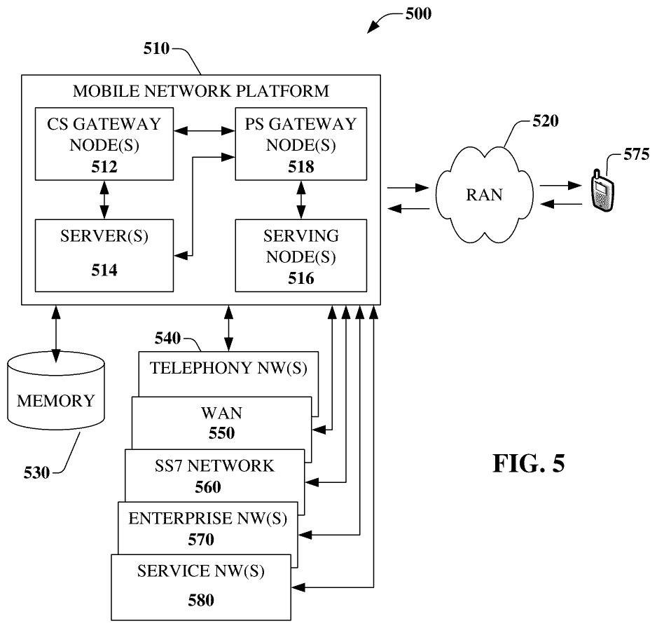

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in systems and methods for automating cloud architecture optimization using a generative artificial intelligence orchestrator. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

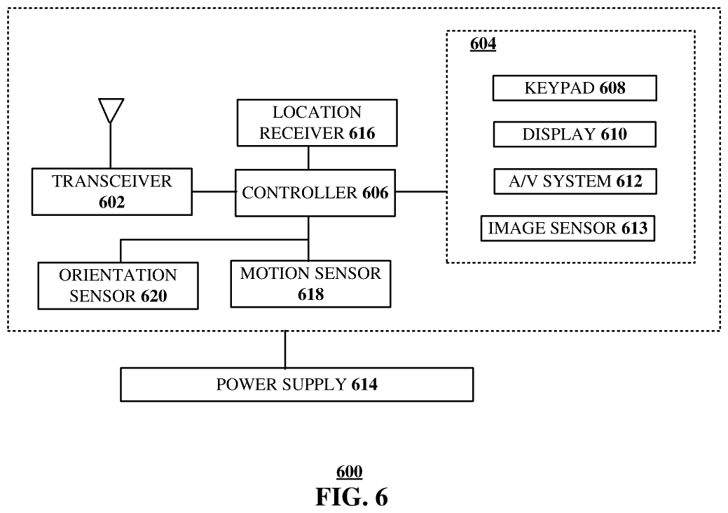

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods for automating cloud architecture optimization using a generative artificial intelligence orchestrator.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof.

Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
running a virtual agent to initiate retrieval of information about cloud subscriptions and cloud resource properties;
connecting the virtual agent with a generative artificial intelligence (GenAI) server via a first application programming interface (API) and a second API;
with the first API, parsing the information about cloud subscriptions and cloud resource properties and generating a prompt for cost saving recommendations;
with a second API, filtering the prompt and sending the prompt that complies with security policies to the GenAI server; and
with the GenAI server, generating cloud architecture optimization (AO) recommendations in response to the prompt.

2. The device of claim 1, wherein the operations further comprise:
receiving cloud AO guidelines by AO architects via a knowledge base portal; and
storing the cloud AO guidelines in a vector database; and
wherein the generating the cloud AO recommendations further comprises, with the GenAI server, generating the AO recommendations by performing a cognitive search in the vector database.

3. The device of claim 1, wherein the operations further comprise training the GenAI server with a set of training data using input parameters retrieved from the cloud subscriptions and the cloud resource properties.

4. The device of claim 1, wherein the operations further comprise:
presenting, with the virtual agent, guided queries to users to retrieve information relating to a target application migrated into a cloud.

5. The device of claim 4, wherein the running the virtual agent further comprises running a chatbot application to retrieve the information relating to the target application including at least identification information of the target application.

6. The device of claim 4, wherein the operations further comprise:
with the first API, receiving, from the virtual agent, the cloud resource properties of the target application and parsing the cloud resource properties of the target application.

7. The device of claim 1, wherein the filtering the prompt further comprises:
determining whether the prompt contains sensitive personal information, payment information, proprietary information, profane words, or a combination thereof.

8. The device of claim 1, wherein the operations further comprise:
with a second API, rejecting the prompt that fails to comply with security policies and sending an error message to the first API,
wherein the first API is a server API and the second API is a GenAI API.

9. A non-transitory machine-readable medium, comprising executable instructions that, when executed by a processing system including a processor, facilitate performance of operations, the operations comprising:
receiving, via a virtual agent, a cloud architecture optimization (AO) request with respect to a target application migrated into a public cloud subscribed by a customer enterprise;
calling, by the virtual agent, a server API to parse an input object containing cloud resource properties owned by a subscription of the target application and generating a prompt using templates;
invoking a generative artificial intelligence API (GenAI API) which performs security policy validations of the prompt;
upon passing of the security policy validations of the prompt, sending the prompt to a GenAI server; and
generating, by the GenAI server, cloud architecture optimization (AO) recommendations.

10. The non-transitory machine-readable medium of claim 9, wherein the operations further comprise invoking, by the virtual agent, a client API to retrieve the cloud resource properties owned by the subscription of the target application.

11. The non-transitory machine-readable medium of claim 9, wherein the operations further comprise:
receiving, via a batch process, the AO request with respect to a group of applications scanned by the batch process and migrated into the public cloud subscribed by the customer enterprise; and
invoking, via the batch process, a client API to retrieve cloud resource properties relevant to the group of applications.

12. The non-transitory machine-readable medium of claim 11, wherein the operations further comprise:
calling, by the batch process, the server API to parse input objects containing the cloud resource properties relevant to the group of applications and to generate another prompt using the templates; and
invoking the GenAI API which performs the security policy validations of another prompt.

13. The non-transitory machine-readable medium of claim 9, wherein the generating the cloud AO recommendations comprises generating the cloud AO recommendations by comparing the prompt with AO guidelines maintained in a vector database using a cognitive search,
wherein the cloud AO recommendations are directed to cost savings by performing resource consolidation, resources optimization, logging optimization, Platform as a Service (PaaS) optimization and PaaS change, converting Infrastructure as a Service (IaaS) to PaaS/Software as a Service (SaaS), or a combination thereof.

14. The non-transitory machine-readable medium of claim 9, wherein the operations further comprises:
generating, with the server API, a first prompt that instructs the GenAI server to output a structured query language (SQL) query;
invoking, with the server API, a particular program code library;
generating, with the server API, a second prompt that instructs the GenAI server to output particular program code using the SQL query; and
calling, with the server API, the particular program code library to execute the particular program code, thereby generating the AO recommendations.

15. The non-transitory machine-readable medium of claim 14, wherein the first prompt comprises a first instruction to generate the SQL query using rules IDs, and the second prompt comprises a second instruction to generate the particular program code using the generated SQL query.

16. A method, comprising:
receiving, by a processing system of a generative artificial intelligence (GenAI) orchestrator including a processor, identification of a target cloud application migrated into a public cloud subscribed by a customer enterprise;
establishing connections, by the processing system, among a server API, a generative artificial intelligence API (GenAI API), and a virtual agent or a batch process;
automatically generating, by the processing system, using the server API, a prompt based on a plurality of rules, wherein the prompt is configured to instruct generation of cloud architecture optimization (AO) recommendations directed to cost savings with respect to the target cloud application;
sending, by the processing system, the prompt to a generative artificial intelligence (GenAI) server via the GenAI API; and
returning, by the processing system, the generated cloud AO recommendations to the virtual agent or the batch process.

17. The method of claim 16, further comprising:
receiving, by the processing system, subscription properties of the target cloud application retrieved by a client API via the virtual agent or the batch process; and
parsing, by the processing system, using the server API, the subscription properties of the target cloud application to generate the prompt.

18. The method of claim 16, further comprising:
calling, by the processing system, a particular program code library; and
connecting, by the processing system, using the server API, the particular program code library and the GenAI API to instruct the GenAI server to generate a particular program code.

19. The method of claim 18, further comprising:
calling, by the processing system, using the server API, a particular program code library to execute the generated particular program code; and
generating, by the processing system, the AO recommendations based on the executed particular program code.

20. The method of claim 16, comprising:
facilitating, by the processing system, connections with user interfaces supporting multiple channels configured to provide a set of parameters relating to the target cloud application in different formats, wherein the multiple channels comprise the virtual agent and the batch process.
